(19) United States
(12) Patent Application Publication
(10) Pub. No.: US 2003/0053101 A1
(43) Pub. Date: Mar. 20, 2003

(54) Image forming apparatus and method of controlling the apparatus

(76) Inventor: Tatsumi Matsumoto, Yokohama-shi (JP)

Correspondence Address: FOLEY AND LARDNER, SUITE 500, 3000 K STREET NW, WASHINGTON, DC, 20007, US

(21) Appl. No.: 09/955,088

(22) Filed: Sep. 19, 2001

(51) Int. Cl. G06F 3/12; B41L 43/10

(52) U.S. Cl. 358/1.13; 399/405

(57) ABSTRACT

If the tray for the copy mode is set at the position corresponding to the discharge port when the copy key is operated, an image is immediately read and the read image is printed on a paper sheet. If the tray for the copy mode is not set at the position corresponding to the discharge port, the tray for the copy mode is moved to the position corresponding to the discharge port, an image is read after completion of trays motion, and the read image is printed on a paper sheet. If the tray for the printer mode is set at the position corresponding to the discharge port when an image is inputted to the input section for the printer mode, the inputted image is immediately printed on a paper sheet. If the tray for the printer mode is not set at the position corresponding to the discharge port, the tray for the printer mode is moved to the position corresponding to the discharge port and the inputted image is printed after completion of trays motion. If the convenient key is operated, an image is immediately read without moving each of the trays and the read image is printed on a paper sheet.

### BACKGROUND OF THE INVENTION

A composite type image forming apparatus, which has a printer mode for printing an image transmitted from an external computer onto paper in addition to a copy mode for optically reading an image of an original document set on an original document table and printing the read image onto paper, is known.

In an example of an image forming apparatus of this kind, a printed paper sheet is received by a sorter.

The sorter includes a tray for the copy mode and a tray for the printer mode, arranged vertically. In the copy mode, the tray for the copy mode moves to a position corresponding to the discharge port described above, and paper sheet is discharged onto the tray for the copy mode. In the printer mode, the tray for the printer mode moves to a position corresponding to the discharge port, and a paper sheet is discharged onto the tray for the printer mode.

By providing this sorter, printed paper sheets can be classified by being stacked according to the mode in which they were printed.

However, when printing in the printer mode ends, the tray for the printer mode is set at the position corresponding to the relevant discharge port. When a copy key is pressed in this state, the tray for the copy mode moves to the position corresponding to the relevant discharge port. After movement thereof is completed, reading and printing of an image is started. In this case, the user must wait while the tray for the copy mode moves to the position corresponding to the relevant discharge port.

### BRIEF SUMMARY OF THE INVENTION

The object of the present invention is to provide an image forming apparatus and method of the controlling the apparatus which are capable of starting image reading and printing in the copy mode without making the user wait, after printing in a mode other than the copy mode ends.

An image forming apparatus according to the present invention comprises:

an original document table which sets an original document;

a read section for a copy mode to optically read an image of the original document set on the original document table;

an input section for a printer mode, which is inputted with an image transferred from outside;

a print section which prints the image read by the read section and the image inputted to the input section, on a paper sheet;

a discharge port which discharges the printed paper;

a sorter having a tray for the copy mode and a tray for the printer mode, which can move freely to a position corresponding to the discharge port, to receive the paper discharged from the discharge port, on any one of the trays;

a first key;

a second key; and

a control section which executes control of a first copy mode in accordance with an operation of the first key, control of the printer mode in accordance with an image input to the input section, and control of a second copy mode in accordance with an operation of the second key, wherein

in the control for the first copy mode, if the tray for the copy mode is set at the position corresponding to the discharge port when the first key is operated, the read section and the print section are immediately operated, or if the tray for the copy mode is not set at the position corresponding to the discharge port, the tray for the copy mode is moved to the position corresponding to the discharge port and the read section and the print section are operated after completion of trays motion,

in the control for the printer mode, if the tray for the printer mode is set at the position corresponding to the discharge port when an image is inputted to the first input section, the print section is immediately operated, or if the tray for the printer mode is not set at the position corresponding to the discharge port, the tray for the printer mode is moved to the position corresponding to the discharge port and the print section is operated after completion of trays motion, and

in the control for the second copy mode, when the second key is operated, the read section and the print section are immediately operated without moving each of the trays.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the outer appearance of an embodiment of the present invention.

FIG. 2 is a view showing the internal structure of the embodiment.

FIG. 3 is a view showing the structure of a control panel of the embodiment.

FIG. 4 is a block diagram of a control circuit of the embodiment.

FIG. 5 is a flowchart for explaining control of the terminal of the embodiment.

### DETAILED DESCRIPTION OF THE INVENTION

In the following, an embodiment of the present invention will be explained with reference to the drawings.

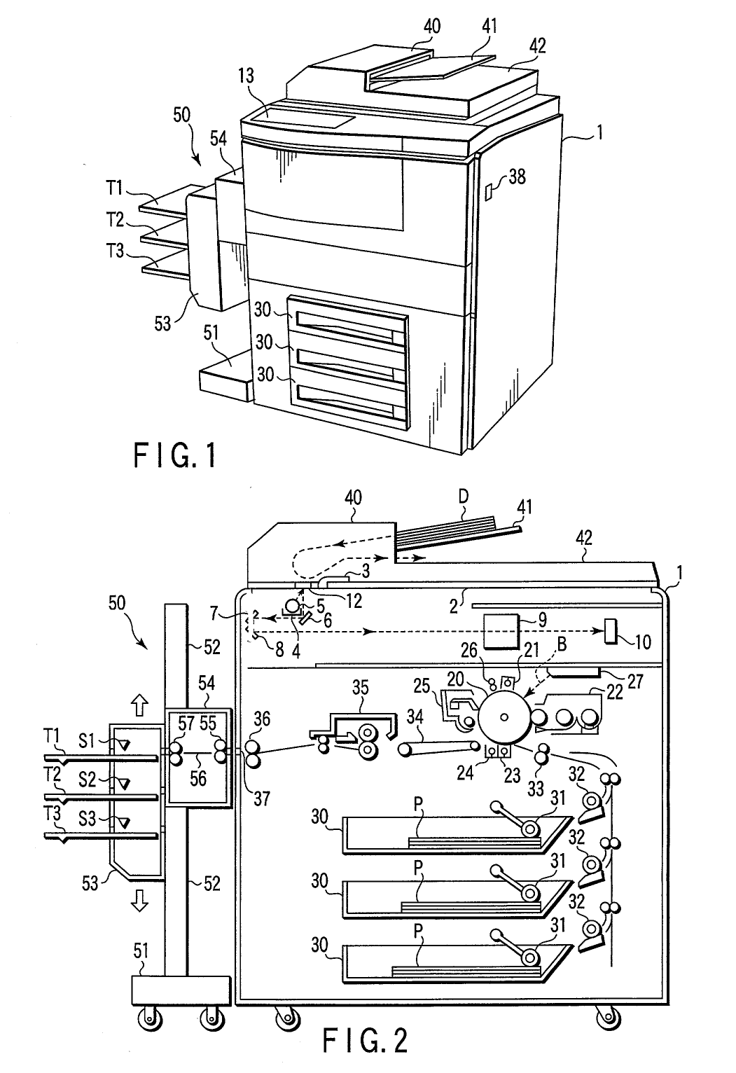

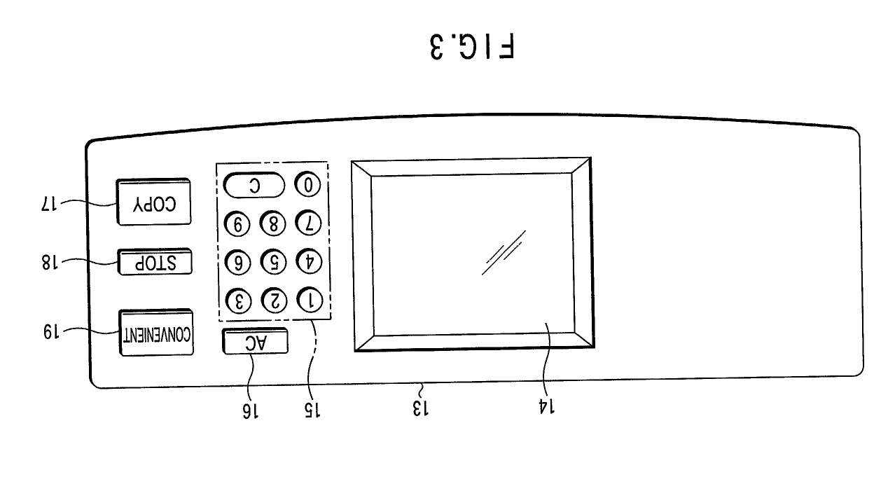

As shown in FIGS. 1 and 2, a transparent document table (glass plate) 2 for setting an original document is provided at an upper surface part of the body 1. An indicator section 3 is provided at an end part of the document table 2. A gap part between the indicator 3 and the document table 2 is a reference position for setting of an original document.

In the lower surface side of the document table 2, there are provided a plurality of original document sensors 11 which will be described later. These document sensors 11 optically detect presence or absence and size of an original document D set on the document table 2.

A carriage 4 is provided in the lower surface side of the document table 2, and an exposure lamp 5 is provided on the carriage 4. An exposure means is constructed by this carriage 4 and the exposure lamp 5. The carriage 4 is capable of moving (reciprocating) along the lower surface of the original document table 2. The exposure lamp 5 turns on, thereby exposing the original document D set on the original document table 2.

By this exposure, a reflection light image from the original document D is obtained and is projected onto a CCD (Charge Coupled Device) 10 by reflection mirrors 6, 7, and 8 and a magnification change lens block 9. The CCD 10 has a large number of photo-electric conversion elements in light receiving regions, and these light receiving regions are subjected to line-scanning thereby to output an image signal corresponding to the image of the original document D.

The image signal outputted from the CCD 10 is amplified and converted into a digital signal. The digital signal is processed by the image processing section 74 described later and is thereafter supplied to a laser unit 27. The laser unit 27 generates a laser beam B corresponding to the input signal.

A window 12 for reading an original document is provided at a position adjacent to the indicator 3 of the document table 2. The window 12 has a size and shape corresponding to the length of the indicator section 3 in its lengthwise direction.

An automatic document feeder (ADF) 40 which also serves as a document table cover is provided to be openable and closable above the original document table 2, indicator 3, and window 12. The automatic document feeder 40 has a tray 41 for setting an original document, feeds a plurality of sheets of the original document D set on the tray 41, one after another, to the window 12 so as to pass over the window 12, and discharges the original document D which has passed to a tray 42. When this automatic document feeder 40 operates, the exposure lamp 5 emits light at a position corresponding to the window 12, and the light is irradiated on the window 12. The light irradiated on the window 12 exposes the original document D passing over the window 12, through the window 12.

At the upper surface part of the body 1, a control panel 13 is provided at a position where the automatic document feeder 40 does not overlap. The control panel 13 comprises a liquid crystal display section 14, a ten-key section 15 for numerical input, an all-clear key 16, a copy key 17 as a first key, a stop key 18, and a convenient key 19 as a second key. The liquid crystal display section 14 is of a finger-operated touch-panel type and can display and set various operation conditions of the apparatus.

Meanwhile, a photosensitive drum 20 is provided to be rotatable at the substantial center part in the body 1. Around this photosensitive drum 20, a charger 21, a developing device 22, a transfer device 23, a peeling device 24, a cleaner 25, and a discharger 26 are provided sequentially. Further, a laser beam B emitted from the laser unit 27 is irradiated on the surface of the photosensitive drum 20, between the charger 21 and the developer 22 through.

At the bottom part of the body 1, there are provided a plurality of paper supply cassettes 30. These paper supply cassettes 30 respectively contain different sizes of paper P. When either the copy key 17 or a convenient key 19 is pressed, paper sheets P are picked out one after another from any one of the paper supply cassettes 30, by pick-up rollers 31. Each of the paper sheets P thus picked out is separated from the cassette 30 by a separator 32 and is supplied to a resist roller 33. The resist roller 33 feeds each paper sheet P between the photosensitive drum 20 and the transfer device 23 at a timing in consideration of rotation of the photosensitive drum 20.

The charger 21 applies a high voltage to the photosensitive drum 20, thereby to charge the surface of the photosensitive drum 20 with an electrostatic charge. The laser beam B emitted from the laser unit 27 is irradiated on the surface of the photosensitive drum 20 after completion of this charging. The laser unit 27 performs main-scanning (line scanning) on the surface of the photosensitive drum 20. By sub-scanning in which the main scanning is repeated in accordance with rotation of the photosensitive drum 20, an electrostatic latent image corresponding to a read image from the original document D is formed on the surface of the photosensitive drum 20.

The electrostatic latent image on the photosensitive drum 20 receives a developing agent (toner) from the developing device 22 and is thereby developed. This developed image is transferred to a paper sheet P by the transfer device 23. The paper sheet P to which the developed image has been transferred is peeled off from the photosensitive drum 20 by the peeling device 24. The developing agent and electric charge remain on the surface of the photosensitive drum 20 from which the paper sheet P has been peeled off. The remaining developing agent is removed by the cleaner 25. The remaining electric charge is removed by the discharger 28.

The paper sheet P peeled off from the photosensitive drum 20 is sent to a fixing device 35. The fixing device fixes the transferred image to the paper sheet P by heat. The paper sheet P after completion of the fixing is sent to a discharge port 37 by a discharge roller 36 and is discharged from the discharge port 37 to the outside of the body 1.

In addition, a sorter 50 is provided so as to contact one side surface of the body (the side where the discharge port 37 is provided). This sorter 50 classifies and stacks paper discharged from the discharge port 37 after completion of printing, according to the mode the copier is in copy mode, printer mode, or facsimile) and comprises a base 51, a rod-like guide 52 provided so as to stand on the base 51, an elevation unit 53 supported on this guide 52 so as to be vertically movable, and an intake unit 54 supported by the guide 52.

The elevation unit 53 has an upper tray T1 for the copy mode, a middle tray T2, and a lower tray T3, which are vertically arranged, and also has paper sensors S1, S2, and S3 for detecting presence or absence of paper sheets P in these trays T1, T2, and T3. By the vertical motion of this elevation unit 53, any one of the trays T1, T2, and T3 is set at a position corresponding to the discharge port 37.

The height position of the intake unit 54 corresponds to that of the discharge port 37, and receives paper sheets P discharged from the discharge port 37, and feeds the received paper sheets P to the elevation unit through a convey route 56 and a rollers 57. The paper sheets P thus fed are stacked in any of the trays T1, T2, and T3.

On another side of the body 1, a power source switch 38 is provided.

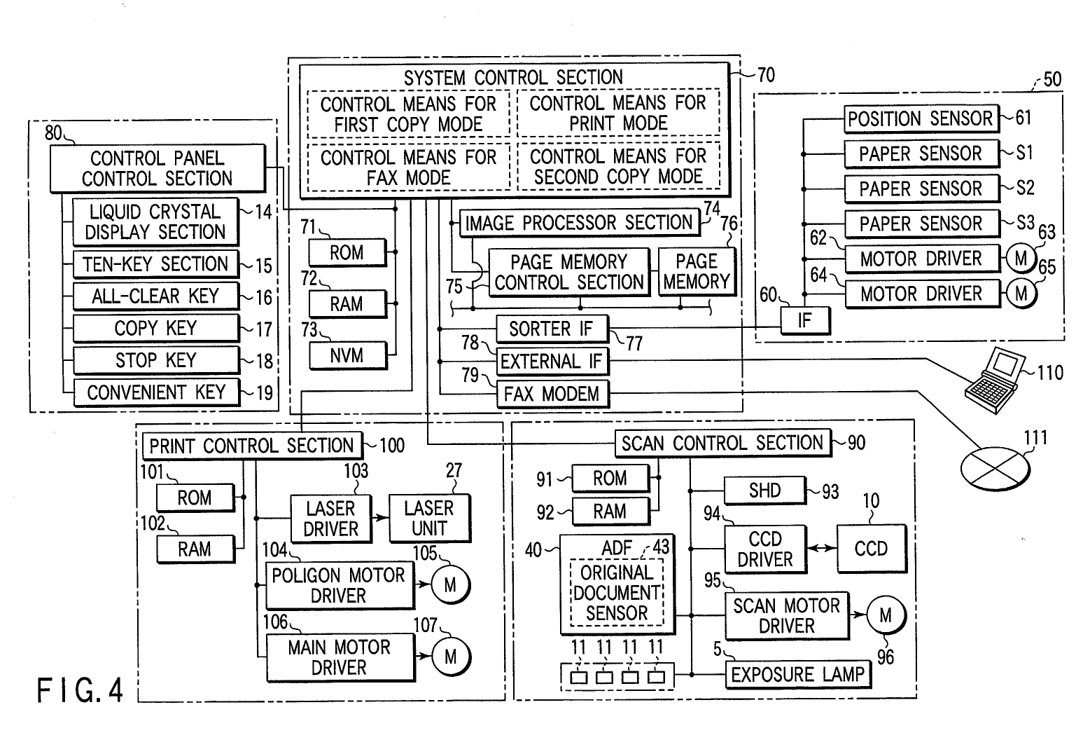

The circuit for controlling the whole apparatus is shown in FIG. 4.

A system control section 70 is connected with a control panel control section 80, a scan control section 90, and a print control section 100. The system control section 70 unitarily controls the control panel control section 80, scan control section 90, and print control section 100, and comprises a control means of the first copy mode in accordance with operation on the copy key 17, a control means of the printer mode in accordance with an image input to an external interface which will be described later, a control means of the facsimile mode (FAX mode) in accordance with image reception through a FAX modem 79 which will be described later, and a control means of the second copy mode in accordance with the convenient key 19.

Also, the system control section 70 is connected to a ROM 71 for storing a control program, a RAM 72 for storing data, an NVM 73, an image processing section 74, a page memory control section 75, a sorter interface 77, an external internal 78, and a FAX modem 79. The image processing section 74 and the memory control section 75 are connected with the page memory 76.

The sorter interface 77 is connected to an interface 60 of the sorter 50. The interface 60 is connected to a position sensor 61, the paper sensors S1, S2, and S3, and motor drivers 62 and 64. The position sensor 61 detects the height position of the elevation unit 53, i.e., the height positions of the trays T1, T2, and T3. The motor driver 62 drives a motor 63 for raising and lowering the elevation unit 53. The motor driver 64 drives the motor 65 for moving the rollers 55, convey route 56, and rollers 57.

The external interface 78 functions as an input section for the printer mode, which is inputted with an image (image data) transferred from the outside. This external interface 78 is connected to an external device, e.g., a personal computer 110. The FAX modem 79 functions as a receiving section for the facsimile mode for receiving a facsimile-transmitted image. This FAX modem 79 is connected with a telephone line 111.

The control panel control section 80 is connected to the liquid crystal display section 14, ten-key section 15, all-clear key 16, copy key 17, stop key 18, and convenient key 19.

The scan control section 90 is connected to the ROM 91 for storing a control program, the RAM 92 for storing data, the shading correction section (SHD) 93, a CCD driver 94, a scan motor driver 95, the exposure lamp 5, the automatic document feeder 50, and respective original document sensors 11. The CCD driver 94 drives the CCD 10. The scan motor driver 95 drives a scan motor 96 for driving the carriage. The automatic document feeder 40 has a document sensor 43 for detecting an original document D set on the tray 41 and its size.

A read section for optically reading an image of an original document D is constructed mainly by the scan control section 90.

The print controller 100 is connected to a ROM 101 for storing a control program, a RAM 102 for storing data, a laser driver 103, a polygon motor driver 104, and a main motor driver 106. The laser driver 103 drives the laser unit 27. The polygon motor driver 104 drives the motor for a polygon mirror for scanning the photosensitive drum 20 with the laser beam B. The main motor driver 106 drives a main motor 107 as a drive source for the photosensitive drum 20 and a paper convey mechanism.

A print section for printing an image read by the read section, an image inputted to the external interface 78, and an image received by the FAX modem respectively onto paper sheets P is constructed mainly by the print control section 100.

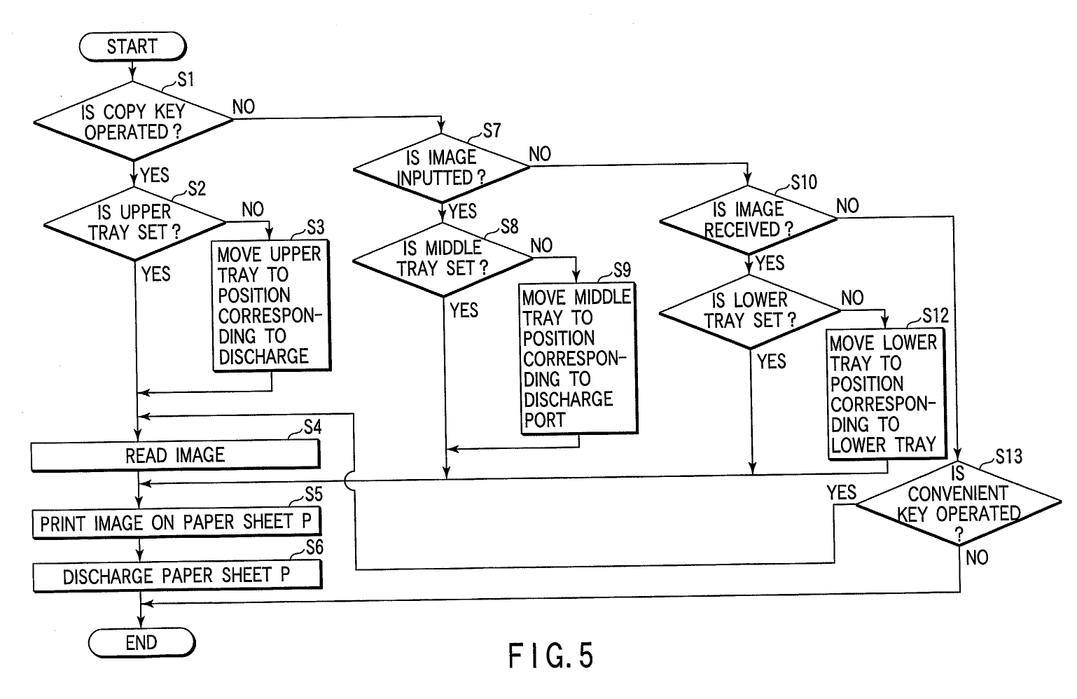

Next, the operation will be explained with reference to the flowchart of FIG. 5.

When an original document D is set on the original document table 2, the setting state thereof is detected by each document sensor 11, and the size of the original document D is detected by each document sensor 11. Further, when the copy key is operated (YES in step S1), whether or not the upper tray T1 for the copy mode is set at the position corresponding to the discharge port 37 (step S2) is detected by the position sensor 61.

If the upper tray T1 is set at the position corresponding to the discharge port 37 (YES in step S2), the image of the original document D is read immediately (step S4), and the read image is printed on a paper sheet P (step S5). The printed paper sheet P is discharged from the discharge port 37 (step S6). The discharged paper sheet P is received by the sorter 50 and is stacked on the upper tray T1.

If the upper tray T1 is not set at the position corresponding to the discharge port 37 (NO in step S2), the upper tray T1 is moved to the position corresponding to the discharge port 37 (step S3). After completion of this motion, the image of the original document D on the document table 2 is read (step S4), and the read image is printed onto a paper sheet P (step S5). The printed paper sheet P is discharged from the discharge port 37 (step S6). The discharged paper sheet P is received by the sorter 50 and is stacked on the upper tray T1.

When an image (image data) transferred from the personal computer 110 is inputted to the external interface 78 (YES in step S7), whether or not the middle tray T2 for the printer mode is set at the position corresponding to the discharge port 37 is detected (step S8).

If the middle tray T2 is set at the position corresponding to the discharge port 37 (YES in step S8), the image of the original document D is immediately printed onto a paper sheet P (step S4). The printed paper sheet P is discharged from the discharge port 37 (step S6). The discharged paper sheet P is received by the sorter 50 and is stacked on the upper tray T1.

If the middle tray T2 is not set at the position corresponding to the discharge port 37 (NO in step S8), the inputted image is immediately printed onto a paper sheet P (step S5). The printed paper sheet P is discharged from the discharge port 37 (step S6). The discharged paper sheet P is received by the sorter 50 and is stacked on the upper tray T1.

When an image (image data) facsimile-transmitted through the telephone line 111 is received by the FAX modem 79 (YES in step S10), whether or not the lower tray T2 for the facsimile mode is set at the position corresponding to the discharge port 37 (step S11) is detected by the position sensor 61.

If the lower tray T1 is set at the position corresponding to the discharge port 37 (YES in step S11), the received image is immediately printed on a paper sheet P (step S5). The printed paper sheet P is discharged from the discharge port 37 (step S6). The discharged paper sheet P is received by the sorter 50 and is stacked on the upper tray T1.

If the lower tray T3 is not set at the position corresponding to the discharge port 37 (NO in step S11), the received image is immediately printed onto a paper sheet P (step S5). The printed paper sheet P is discharged from the discharge port 37 (step S6). The discharged paper sheet P is received by the sorter 50 and is stacked on the upper tray T1.

When the convenient key 19 is operated with an original document D set on the original document table 2 (YES in step S13), the image of the original document D on the original document table 2 is read immediately (step S4), and the read image is printed onto a paper sheet P (step S5). The paper sheet P after completion of the printing is discharged from the discharge port 37 (step S6). The discharged paper sheet P is received by the sorter 50 and is stacked on any of the trays T1, T2, and T3.

For example, when printing in the printer mode ends, the middle tray T2 for the printer mode is set at the position corresponding to the discharge port 37. When the convenient key 19 is depressed in this state, printed papers are stacked on the middle tray T2 for the printer mode.

If printing in the facsimile mode ends, the lower tray T3 is set at the position corresponding to the discharge port 37. When the convenient key 19 is operated in this state, printed paper sheets P are stacked on the lower tray T3 for the facsimile mode.

By thus operating the convenient key 19, image reading and printing in the copy mode can be started immediately, regardless of the positions of the trays T1, T2, and T3. In this manner, it is unnecessary to wait in front of the body 1, thus the user's time can be spent more efficiently.

Additional advantages and modifications will readily occur to those skilled in the art. Therefore, the invention in its broader aspects is not limited to the specific details and representative embodiments shown and described herein. Accordingly various modifications may be made without departing from the spirit or scope of the general inventive concept as defined by the appended claims and their equivalents.

What is claimed is:

1. An image forming apparatus comprising:
an original document table which sets an original document;
a read section for a copy mode to optically read an image of the original document set on the original document table;
an input section for a printer mode, which is inputted with an image transferred from outside;
a print section which prints the image read by the read section and the image inputted to the input section, on a paper sheet;
a discharge port which discharges the printed paper sheet;
a sorter having a tray for the copy mode and a tray for the printer mode, which can move freely to a position corresponding to the discharge port, to receive the paper discharged from the discharge port, on any one of the trays;
a first key;
a second key; and
a control section which executes control of a first copy mode in accordance with an operation of the first key, control of the printer mode in accordance with an image input to the input section, and control of a second copy mode in accordance with an operation of the second key, wherein
in the control for the first copy mode, if the tray for the copy mode is set at the position corresponding to the discharge port when the first key is operated, the read section and the print section are immediately operated, or if the tray for the copy mode is not set at the position corresponding to the discharge port, the tray for the copy mode is moved to the position corresponding to the discharge port and the read section and the print section are operated after completion of trays motion,
in the control for the printer mode, if the tray for the printer mode is set at the position corresponding to the discharge port when an image is inputted to the first input section, the print section is immediately operated, or if the tray for the printer mode is not set at the position corresponding to the discharge port, the tray for the printer mode is moved to the position corresponding to the discharge port and the print section is operated after completion of trays motion, and
in the control for the second copy mode, when the second key is operated, the read section and the print section are immediately operated without moving each of the trays.

2. The apparatus according to claim 1, wherein the sorter has an elevation unit for moving up and down each of the trays.

3. The apparatus according to claim 1, further comprising a control panel provided with the first and second keys.

4. The apparatus according to claim 1, further comprising a receiving section for a facsimile mode to receive an image which is facsimile-transmitted.

5. The apparatus according to claim 4, wherein
the print section further prints the image received by the receiving section,
the sorter further has a tray for the facsimile mode, and
the sorter further executes control for the facsimile mode, and in the control for the facsimile mode, if the tray for the facsimile mode is set at the position corresponding to the discharge port when an image is received by the receive section, the print section is immediately operated, or if the tray for the facsimile mode is not set at the position corresponding to the discharge port, the tray for the facsimile mode is moved to the position corresponding to the discharge port and the print section is operated after completion of trays motion.

6. The apparatus according to claim 5, wherein the sorter has an elevation unit for moving up and down each of the trays.

7. The apparatus according to claim 5, further comprising a control panel provided with the first and second keys.

8. A method of controlling the image forming apparatus including
an original document table for setting an original document,
a read section for a copy mode to optically read an image of the original document set on the original document table,
an input section for a printer mode, which is inputted with an image transferred from outside,
a print section for printing the image read by the read section and the image inputted to the input section, on a paper sheet,
a discharge port for discharging the printed paper sheet,
a sorter having a tray for the copy mode and a tray for the printer mode, which can move freely to a position corresponding to the discharge port, to receive the paper sheet discharged from the discharge port, on any one of the trays, and
a first key, the method comprising:
a step in the first copy mode in which if the tray for the copy mode is set at the position corresponding to the discharge port when the first key is operated, the read section and the print section are immediately operated, or if the tray for the copy mode is not set at the position corresponding to the discharge port, the tray for the copy mode is moved to the position corresponding to the discharge port and the read section and the print section are operated after completion of trays motion;
a step in the printer mode in which if the tray for the printer mode is set at the position corresponding to the discharge port when an image is inputted to the first input section, the print section is immediately operated, or if the tray for the printer mode is not set at the position corresponding to the discharge port, the tray for the printer mode is moved to the position corresponding to the discharge port and the print section is operated after completion of trays motion and
a step in the second copy mode in which when the second key is operated, the read section and the print section are immediately operated without moving each of the trays.

9. The method according to claim 8, wherein the apparatus comprises a receiving section for a facsimile mode to receive image which is facsimile-transmitted,
the print section further prints the image received by the receiving section,
the sorter further has a tray for the facsimile mode.

10. The method according to claim 9, further comprising a step in a facsimile mode in which if the tray for the facsimile mode is set at the position corresponding to the discharge port when an image is received by the receive section, the print section is immediately operated, or if the tray for the facsimile mode is not set at the position corresponding to the discharge port, the tray for the facsimile mode is moved to the position corresponding to the discharge port and the print section is operated after completion of trays motion.

11. An image forming apparatus comprising:
an original document table for setting an original document;
a read section for a copy mode to optically read an image of the original document set on the original document table;
an input section for a printer mode, which is inputted with an image transferred from outside;
a print section for printing the image read by the read section and the image inputted to the input section, on a paper sheet;
a discharge port for discharging the printed paper sheet;
a sorter having a tray for the copy mode and a tray for the printer mode, which can move freely to a position corresponding to the discharge port, to receive the paper sheet discharged from the discharge port, on any one of the trays;
a first key;
a second key;
control for a first copy mode in which if the tray for the copy mode is set at the position corresponding to the discharge port when the first key is operated, the read section and the print section are immediately operated, or if the tray for the copy mode is not set at the position corresponding to the discharge port, the tray for the copy mode is moved to the position corresponding to the discharge port and the read section and the print section are operated after completion of trays motion;
control means for the printer mode in which, if the tray for the printer mode is set at the position corresponding to the discharge port when an image is inputted to the first input section, the print section is immediately operated, or if the tray for the printer mode is not set at the position corresponding to the discharge port, the tray for the printer mode is moved to the position corresponding to the discharge port and the print section is operated after completion of trays motion; and
control means for the second copy mode in which, when the second key is operated, the read section and the print section are immediately operated without moving each of the trays.

12. The apparatus according to claim 11, wherein the sorter has an elevation unit for moving up and down each of the trays.

13. The apparatus according to claim 11, further comprising a control panel provided with the first and second keys.

14. The apparatus according to claim 11, further comprising a receiving section for a facsimile mode to receive image which is facsimile-transmitted.

15. The apparatus according to claim 14, wherein
the print section further prints the image received by the receiving section, and
the sorter further has a tray for the facsimile mode.

16. The apparatus according to claim 15, further comprising
control means for the facsimile mode in which, if the tray for the facsimile mode is set at the position corresponding to the discharge port when an image is received by the receive section, the print section is immediately operated, or if the tray for the facsimile mode is not set at the position corresponding to the discharge port, the tray for the facsimile mode is moved to the position corresponding to the discharge port and the print section is operated after completion of trays motion.
